(19) United States
(12) Patent Application Publication
(10) Pub. No.: US 2016/0025038 A1
(43) Pub. Date: Jan. 28, 2016

(54) PIVOT DOOR THRUST REVERSER

(71) Applicant: UNITED TECHNOLOGIES CORPORATION, Hartford, CT (US)

(72) Inventor: Nigel David Sawyers-Abbott, South Glastonbury, CT (US)

(21) Appl. No.: 14/770,195

(22) PCT Filed: Mar. 11, 2014
(86) PCT No.: PCT/US2014/022955

§ 371 Date: Aug. 25, 2015

Related U.S. Application Data
(60) Provisional application No. 61/788,377, filed on Mar. 15, 2013.

(51) Int. Cl. F02K 1/72; F01D 15/12; F01D 25/24; F01D 5/02; F01D 17/10

(52) U.S. Cl. CPC F02K 1/72; F01D 5/02; F01D 17/105; F01D 25/24; F01D 15/12; F05D 2220/36; F05D 2260/40311

(57) ABSTRACT

A geared turbofan engine includes a fan, a low pressure turbine, a geared architecture, and a nacelle. The fan and low pressure turbine are capable of rotation about an axial centerline of the gas turbine engine. The geared architecture connects the fan to be driven by the low pressure turbine. The nacelle is disposed circumferentially around the fan and defines a portion of a bypass flow duct. The nacelle includes a thrust reverser assembly with one or more doors that pivot to block at least a portion of the bypass flow duct in a deployed position.

### CROSS-REFERENCE TO RELATED APPLICATION(S)

This application claims the benefit of PCT application PCT/US2014/022955, filed Mar. 11, 2014, for “Pivot Door Thrust Reverser” by Nigel David Sawyers-Abbott, and U.S. Provisional Application No. 61/788,377, and filed Mar. 15, 2013, for “Pivot Door Thrust Reverser” by Nigel David Sawyers-Abbott.

### BACKGROUND

This disclosure relates to gas turbine engines, and in particular, to a thrust reverser for a gas turbine engine.

Modern aircraft turbofan engines include a fan nacelle surrounding a core nacelle. The core nacelle encloses a core compartment that houses the core. The core drives a fan arranged in a bypass flow path formed between the core and fan nacelles. A large proportion of the total thrust of the engine is developed by the reaction to the air driven rearward through the bypass flow path by the fan.

Modern aircraft to have high landing speeds, placing great stress on wheel braking systems and requiring very long runways. To reduce this braking requirement and permit use of shorter runways, means are now provided in such engines for reversing a major portion of engine thrust during the landing roll.

### SUMMARY

A geared turbofan engine with a bypass ratio greater than six includes a fan, a first spool, a second spool, a geared architecture, and a nacelle. The, fan, first spool and second spools are capable of rotation about an axial centerline of the gas turbine engine. The fan is coupled to the low pressure compressor and the low pressure turbine through the geared architecture. The nacelle is arranged circumferentially around the axial centerline and defines a portion of a bypass flow duct. The nacelle includes a thrust reverser assembly with one or more doors that pivot to block at least a portion of the bypass flow duct in a deployed position. The thrust reverser has an effective flow area that is greater than a bypass flow duct exit area of the bypass flow duct.

A geared turbofan engine includes a fan, a low pressure turbine, a geared architecture, and a nacelle. The fan and low pressure turbine are capable of rotation about an axial centerline of the gas turbine engine. The geared architecture connects the fan to be driven by the low pressure turbine. The nacelle is disposed circumferentially around the fan and defines a portion of a bypass flow duct. The nacelle includes a thrust reverser assembly with one or more doors that pivot to block at least a portion of the bypass flow duct in a deployed position. The thrust reverser has an effective flow area that is greater than or equal to 110% of a bypass flow duct exit area of the bypass flow duct.

### BRIEF DESCRIPTION OF THE DRAWINGS

FIG. 1 is a cross section of a schematic gas turbine engine.

FIG. 2A is a perspective view of the gas turbine engine with thrust reverser doors in a stowed position.

FIG. 2B is a perspective view of the gas turbine engine with thrust reverser doors pivoted into a deployed position.

FIG. 3A is a cross sectional view of one embodiment of the thrust reverser doors in the stowed position.

FIG. 3B is a cross sectional view of the thrust reverser doors of FIG. 3A pivoted to the deployed position.

### DETAILED DESCRIPTION

As turbofan engines become increasingly more complex and efficient, the higher their bypass ratios become. A higher bypass ratio in a turbofan engine 20 leads to better fuel burn because the fan 42 is more efficient at producing thrust than the core engine 12. The introduction of a fan drive gear system 48 for turbofan engines 20 has also led to smaller engine cores, which are housed within the core nacelle 62. The turbofan engine 20 described herein utilizes a pivot door thrust reverser assembly 66. The pivot door thrust reverser assembly 66 reduces aircraft braking requirements and permits the use of shorter runways by reversing a major portion of engine thrust during the landing roll. Thrust reverser assembly 66 slows down the aircraft by preventing gas turbine engine 10 from generating forward fan thrust and by generating reverse thrust to counteract primary thrust, and in some embodiments creating additional drag.

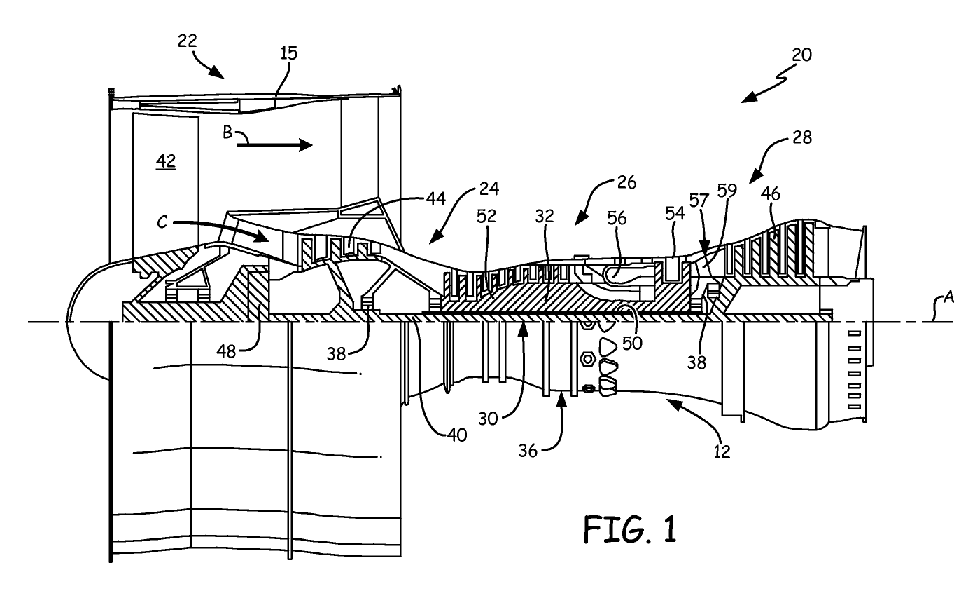

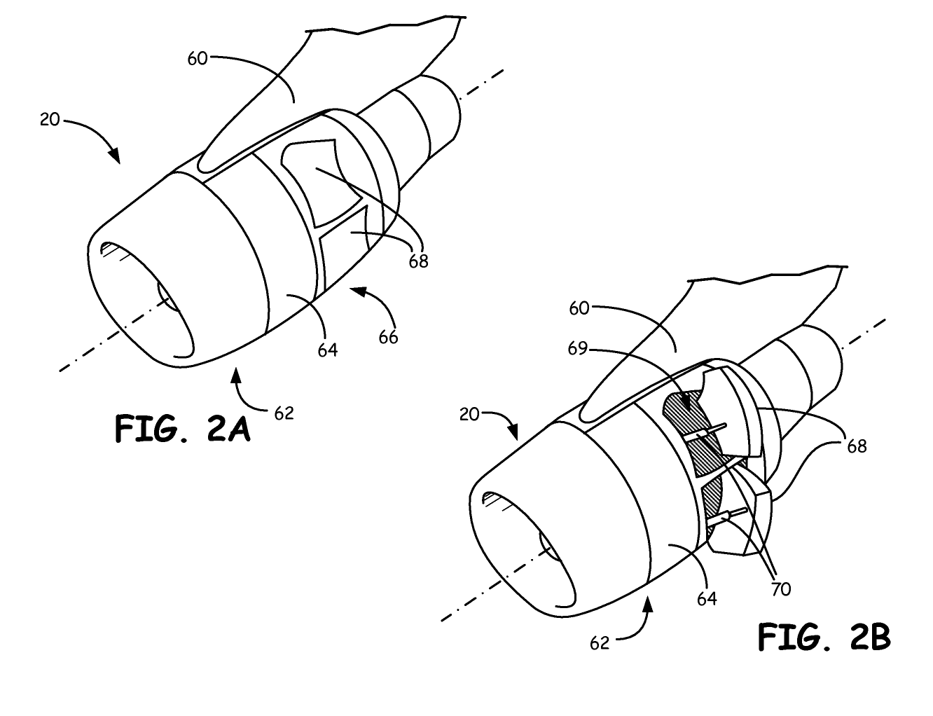

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22, the compressor section 24, and the combustor section 26 are collectively known as a core engine 12. Alternative engines might include an augmenter section (not shown) among other systems or features. The fan section 22 drives air along a bypass flowpath B in a bypass duct defined within a fan case 15 and nacelle (FIGS. 2A and 2B), while the compressor section 24 drives air along a core flowpath C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The gas turbine engine 20 generally includes a low speed spool 30 also (referred to as the low pressure spool) and a high speed spool 32 (also referred to as the high pressure spool). The spools 30, 32 are mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. A fan case 15 surrounds the fan 42. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The gas turbine engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of equal to or greater than about 2.3 and the low pressure turbine 46 has a pressure ratio that is greater than about five (5). In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

FIGS. 2A and 2B illustrate the gas turbine engine 20 mounted to a pylon 60. The gas turbine engine 10 includes a nacelle 62. The nacelle 62 includes an outer cowl 64 and a thrust reverser assembly 66. The thrust reverser assembly 66 includes doors 68 and actuator 70.

The gas turbine engine 20 is mounted to a wing (not shown) by the pylon 60. The nacelle 62 encloses the remainder of the gas turbine engine 20 including the core engine 12 (FIG. 1). The outer cowl 64 comprises the outer portion of the nacelle 12. The thrust reverser assembly 66 is mounted to an aft portion of the outer cowl 64. As used herein, terms such as “front”, “forward”, “aft”, “rear”, “rearward” should be understood as positional terms in reference to the direction of airflow such as bypass flow B (FIG. 1) through nacelle 62.

In FIGS. 2A and 2B, thrust reverser assembly 66 comprises a pivoting door type thrust reverser and includes doors 68. Each door 68 can be pivoted by a corresponding actuator 70 (shown in FIG. 2B only) between a stowed position and a deployed position. When operated to the deployed position of FIG. 2B, thrust reverser assembly 66 reduces aircraft braking requirements and permits the use of shorter runways by reversing a major portion of engine thrust during the landing roll. Thrust reverser assembly 66 slows down the aircraft by preventing gas turbine engine 10 from generating forward fan thrust and by generating reverse thrust to counteract primary thrust, and in some embodiments create additional drag.

In FIG. 2A, the doors 68 are shown in the stowed position where the doors 68 generally conform with the shape of the outer cowl 64. Thus, in the stowed position the doors 68 are disposed in a substantially parallel relationship to the longitudinal axis of the engine. This allows for aerodynamic smoothness along the outer surface of the nacelle 62 and within the fan duct so as to minimize drag due to the doors 68.

In FIG. 2B, the doors 68 have been pivoted by the actuators 70 to the deployed position where the doors 68 extend outward from the outer cowl 64 and into fan duct enclosed by the outer cowl 64. The doors 68 block the fan duct to redirect bypass flow B (FIG. 1) in a forward direction through recesses 69 that had previously housed the doors 68. By blocking the fan duct, the doors 68 prevent the bypass flow B from generating the forward fan thrust. The doors 68 turn the bypass flow B forward to generate reverse thrust that counteracts the primary thrust, and create additional drag where doors 68 are proud of the outer surface of nacelle 62. Further discussion of the construction and operation of components of a pivoting door type thrust reverser assembly 66 are discussed in U.S. Pat. No. 8,182,175, and U.S. Pat. No. 8,127,530, which are both incorporated herein by reference.

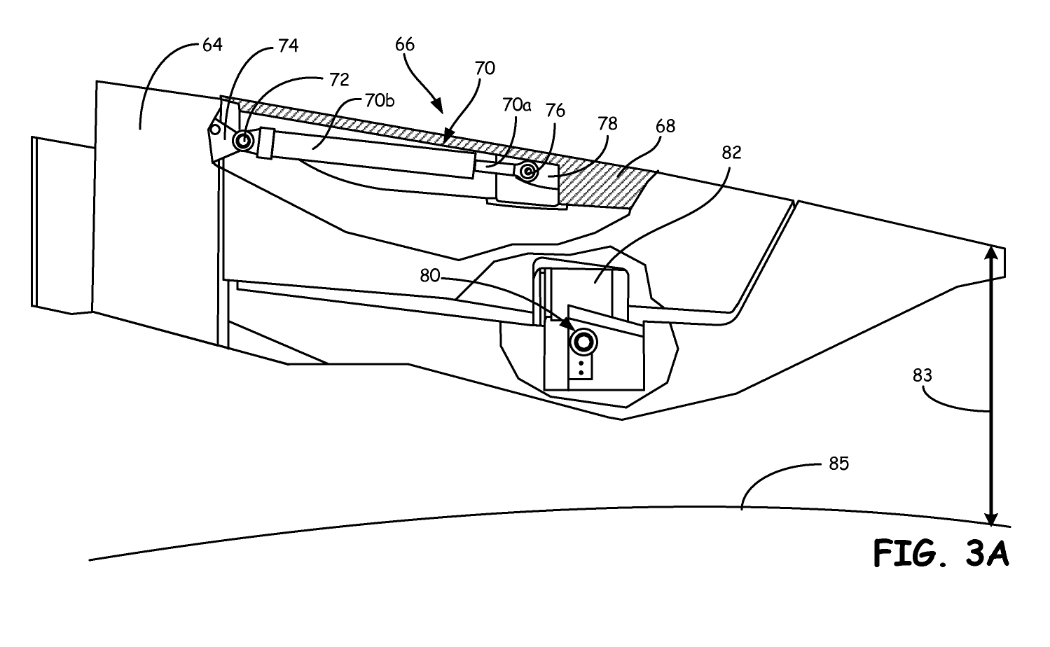

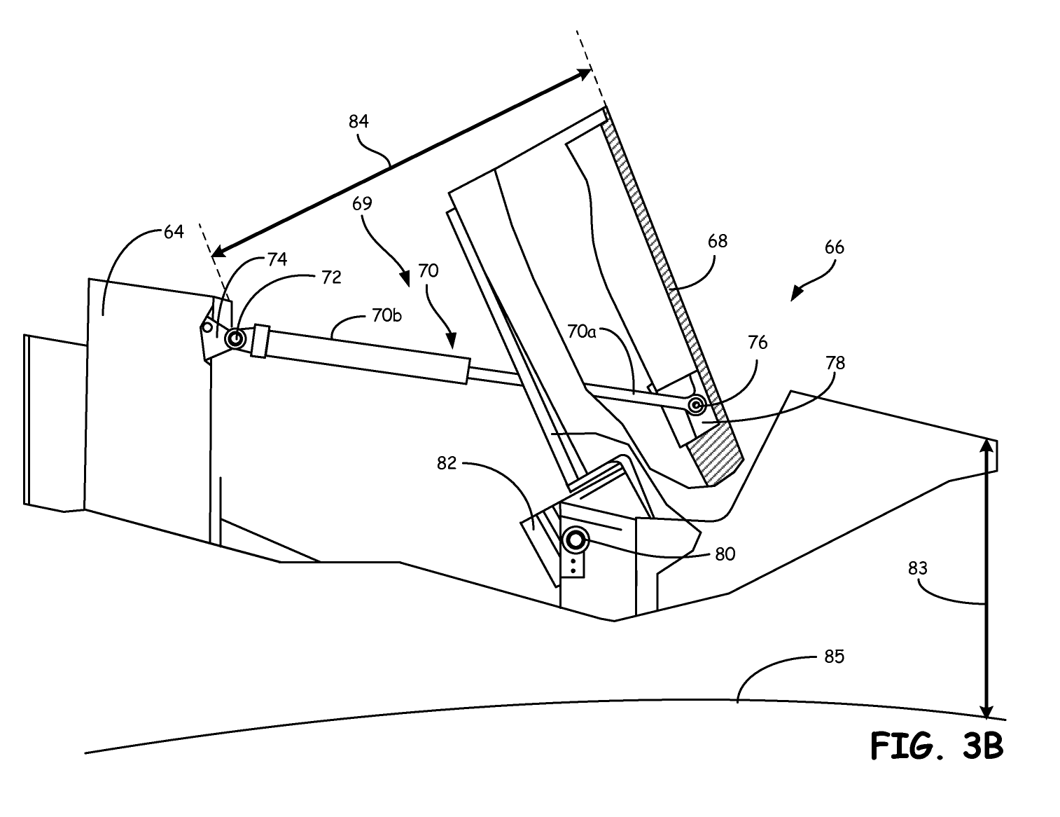

FIGS. 3A and 3B show a partial sectional view of one example of thrust reverser assembly 66. In addition to the door 68 and the actuator 70, the thrust reverser assembly 66 includes a first pivot connection 72, a first fitting 74, a second pivot connection 76, a second fitting 78, hinges 80 (only one is shown in FIGS. 3A and 3B), and a beam 82. The actuator 70 includes a rod 70a and a sleeve 70b.

In FIG. 3A, one door 68 is illustrated in a partial sectional view. The door 68 is disposed in the stowed position relative to the outer cowl 64. The sleeve 70b of actuator 70 is pivotally connected to outer cowl 64 and the rod 70a of actuator 70 is pivotally connected to the door 68. In particular, sleeve 70b utilizes the first pivot connection 72 to mount to the first fitting 74. The first fitting 74 is affixed to the stationary outer cowl 64 below the exterior surface thereof. The actuator 70 extends forward from the first pivot connection 72 and rod 70a of actuator 70 connects to the second pivot connection 76. The second pivot connection 76 connects the rod 70a to the door 68 via the second fitting 78. The hinges 80 are disposed to each side of the door 68. In FIG. 3A, the hinges 80 are connected to the beam 82. The hinge 80 and the beam 82 allow the door 68 to pivot relative to the outer cowl 64 when actuated by the actuator 70.

In one embodiment, the first pivot connection 72 and the second pivot connection 76 utilize coupling bolts. Similarly, the hinges 80 each utilize a coupling bolt. The bolts may be secured in place by nuts and/or additional hardware such as washers or bushings. The beam 82 is connected to the door 68 and extends across the door 68 from one hinge to another. In the embodiment of FIGS. 3A and 3B the actuator 70 is illustrated as a telescoping rod 70a and sleeve 70b device that can be driven by known means such as hydraulics or a motor. In other embodiments, other types of extending devices such as slider tracker arrangements, worm gears, or other additional or alternative systems that provide for relative pivotal movement between the door 68 and the outer cowl 64 can be used. Bypass flow duct exit area 83 is measured at the bypass flow exit plain between nacelle outer cowl 64 trailing edge and core nacelle 85.

In FIG. 3B, the doors 68 have been pivoted on the hinges 80 by the actuators 70 to the deployed position where the doors 68 extend outward from the outer cowl 64 and into fan duct enclosed by the outer cowl 64 and the free stream air flow. The doors 68 block some or all of the fan duct to redirect bypass flow B (FIG. 1) in a forward direction through recesses 69 that had previously housed the doors 68. By blocking the fan duct, the doors 68 prevent some or all of the bypass flow B from generating forward fan thrust, and creates additional drag in the free stream air flow. The doors 68 turn the bypass flow B forward to generate reverse thrust that counteracts the primary thrust. In one embodiment, an effective flow area 84 of thrust reverser 66 is greater than or equal to about 110% of bypass flow duct exit area 83. [Insert text]

### DISCUSSION OF POSSIBLE EMBODIMENTS

The following are non-exclusive descriptions of possible embodiments of the present invention.

A geared turbofan engine with a bypass ratio greater than six includes a fan, a first spool, a second spool, a geared architecture, and a nacelle. The, fan, first spool and second spools are capable of rotation about an axial centerline of the gas turbine engine. The fan is coupled to the low pressure compressor and the low pressure turbine through the geared architecture. The nacelle is arranged circumferentially around the axial centerline and defines a portion of a bypass flow duct. The nacelle includes a thrust reverser assembly with one or more doors that pivot to block at least a portion of the bypass flow duct in a deployed position. The thrust reverser has an effective flow area that is greater than a bypass flow duct exit area of the bypass flow duct.

The gas turbine engine of the preceding paragraph can optionally include, additionally and/or alternatively, any one or more of the following features, configurations and/or additional components:

the one or more doors pivot on hinges;

an actuator that drives the one or more pivoting doors between a stowed position and a deployed position;

the actuator includes a rod that is extensible and retractable;

a fan, a low pressure compressor section, a high pressure compressor section, a combustor section, a low pressure turbine section, and a high pressure turbine section;

the first spool comprises the high pressure compressor and the high pressure turbine;

the second spool comprises the low pressure compressor and the low pressure turbine;

the effective flow area is greater than or equal to about 110% of the bypass flow duct exit area;

the geared architecture comprises an epicyclic transmission;

the epicyclic transmission is a planetary gear system with a gear reduction ratio of equal to or greater than 2.3;

the engine has a bypass ratio that is greater than six; and

the bypass ratio is greater than ten.

A geared turbofan engine includes a fan, a low pressure turbine, a geared architecture, and a nacelle. The fan and low pressure turbine are capable of rotation about an axial centerline of the gas turbine engine. The geared architecture connects the fan to be driven by the low pressure turbine. The nacelle is disposed circumferentially around the fan and defines a portion of a bypass flow duct. The nacelle includes a thrust reverser assembly with one or more doors that pivot to block at least a portion of the bypass flow duct in a deployed position. The thrust reverser has an effective flow area that is greater than or equal to 110% of a bypass flow duct exit area of the bypass flow duct.

The geared turbofan engine of the preceding paragraph can optionally include, additionally and/or alternatively, any one or more of the following features, configurations and/or additional components:

the one or more doors pivot on hinges;

an actuator drives the one or more pivoting doors between a stowed position and a deployed position;

the actuator includes a rod that is extensible and retractable;

the geared architecture comprises an epicyclic transmission;

the epicyclic transmission is a planetary gear system with a gear reduction ratio of equal to or greater than 2.3;

the engine has a bypass ratio that is greater than six; and

the bypass ratio is greater than ten.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A geared turbofan engine with a bypass ratio that is greater than six, the engine comprising:
a first spool capable of rotation about an axial centerline of the gas turbine engine;
a second spool capable of rotation about the axial centerline;
a fan capable of rotation about the axial centerline;
a geared architecture, wherein the fan is coupled to the low pressure compressor and the low pressure turbine through the geared architecture; and
a nacelle arranged circumferentially around the axial centerline and defining a portion of a bypass flow duct, the nacelle comprising:
a thrust reverser assembly with one or more doors that pivot to block at least a portion of the bypass flow duct in a deployed position, wherein the thrust reverser has an effective flow area that is greater than a bypass flow duct exit area of the bypass flow duct.

2. The geared turbofan engine of claim 1, wherein the one or more doors pivot on hinges.

3. The geared turbofan engine of claim 1, wherein an actuator drives the one or more pivoting doors between a stowed position and a deployed position.

4. The geared turbofan engine of claim 3, wherein the actuator includes a rod that is extensible and retractable.

5. The geared turbofan engine of claim 1, wherein the first and second spools include a fan, a low pressure compressor, a high pressure compressor, a low pressure turbine, and a high pressure turbine.

6. The geared turbofan engine of claim 5, wherein the first spool comprises the high pressure compressor and the high pressure turbine.

7. The geared turbofan engine of claim 5, wherein the second spool comprises the low pressure compressor and the low pressure turbine.

8. The geared turbofan engine of claim 1, wherein the effective flow area is greater than or equal to about 110% of the bypass flow duct exit area.

9. The gas turbine engine of claim 1, wherein the geared architecture comprises an epicyclic transmission.

10. The geared turbofan engine of claim 9, wherein the epicyclic transmission is a planetary gear system with a gear reduction ratio of equal to or greater than 2.3.

11. The geared turbofan engine of claim 1, wherein the bypass ratio is greater than ten.

12. A geared turbofan engine, comprising:
a fan capable of rotation about an axial centerline of the gas turbine engine;
a low pressure turbine capable of rotation about the axial centerline;
a geared architecture connecting the fan to be driven by the low pressure turbine; and
a nacelle disposed circumferentially around the fan and defining a portion of a bypass flow duct, the nacelle comprising:
a thrust reverser assembly with one or more doors that pivot to block at least a portion of the bypass flow duct in a deployed position, the thrust reverser has an effective flow area that is greater than or equal to 110% of a bypass flow duct exit area of the bypass flow duct.

13. The engine of claim 12, wherein the one or more doors pivot on hinges.

14. The engine of claim 12, wherein an actuator drives the one or more pivoting doors between a stowed position and a deployed position.

15. The engine of claim 14, wherein the actuator includes a rod that is extensible and retractable.

16. The engine of claim 12, wherein the geared architecture comprises an epicyclic transmission.

17. The engine of claim 16, wherein the epicyclic transmission is a planetary gear system with a gear reduction ratio of equal to or greater than 2.3.

18. The engine of claim 12, wherein the engine has a bypass ratio that is greater than six.

19. The engine of claim 18, wherein the bypass ratio is greater than ten.
